(19) United States
(12) Patent Application Publication
(10) Pub. No.: US 2015/0084879 A1
(43) Pub. Date: Mar. 26, 2015

(54) NAIL-MOUNTED DISPLAY SYSTEM

(71) Applicant: National Taiwan University, Taipei (TW)

(72) Inventors: Bing-Yu Chen, Taipei (TW); Chao-Huai Su, Taipei (TW); Li-Wei Chan, Taipei (TW); Chien-Ting Weng, Taipei (TW); Rong-Hao Liang, Taipei (TW); Kai-Yin Cheng, Taipei (TW)

(73) Assignee: NATIONAL TAIWAN UNIVERSITY, Taipei (TW)

(21) Appl. No.: 14/151,170

(22) Filed: Jan. 9, 2014

(30) Foreign Application Priority Data
Sep. 24, 2013 (TW) 102134240

(51) Int. Cl. G06F 3/041

(52) U.S. Cl. CPC G06F 3/041
USPC 345/173

(57) ABSTRACT

A nail-mounted display system includes an electronic device and a display device in communication with the electronic device. The electronic device includes a touch interface with a touch location; a positioning module for generating positioning information corresponding to the touch location; an information module for obtaining the operating information corresponding to the touch location on the touch interface based on the positioning information; and a transmission module for outputting the operating information obtained by the information module. The display device is worn on a finger of a user for receiving the operating information from the electronic device so as to display an image corresponding to the operating information when the finger is in contact with the touch interface.

### FIELD OF THE INVENTION

The present invention relates to a display system, and more particularly, to a nail-mounted display system.

### BACKGROUND OF THE INVENTION

Currently, rapid technological development has accelerated the development and varieties of personalized electronic products, such as media players, smart phones or tablet computers. These electronic products with diverse functions provide desired convenience for users.

The various types of electronic devices are all manipulated through contact with user's finger(s), and are thus called touch devices. For example, the standard structure of a smart phone includes a touch display on the surface of the phone. A user can derive information displayed on the touch display of the phone. When the user would like to operate the phone, he/she can operate the smart phone through actions such as clicking and/or dragging on the display directly. However, when the user is viewing the information displayed on the touch display, some part of the display is blocked by the user's finger and cannot be seen.

Moreover, in addition to smart phones, digital media players commonly known as MP3 players are also common personalized electronic devices. Because of the small size, MP3 players are easy to carry and easy to operate, and are therefore popular. However, some of the MP3 players are not equipped with displays, so that users cannot gain the state of MP3 players when operating the MP3 players.

Therefore, there is a need to develop a solution that addresses the problem resulting from electronic products with no display screens or the screens being blocked during manual input.

### SUMMARY OF THE INVENTION

The present invention provides a nail-mounted display system for a user to wear a display device on his/her finger so as to display information coming from an electronic device.

A nail-mounted display system in accordance with an embodiment of the present invention may include an electronic device and a display device in communication with the electronic device. The electronic device may include a touch interface to be in contact with a finger of a user for operating the electronic device, wherein where the finger is in contact with the touch interface is defined as a touch location, and the touch interface has operating information corresponding to the touch location; a positioning module for generating positioning information corresponding to the touch location when the finger is in contact with the touch interface; an information module for obtaining the operating information corresponding to the touch location on the touch interface based on the positioning information; and a transmission module for outputting the operating information obtained by the information module. The display device is worn on the finger for receiving the operating information corresponding to the touch location to display an image corresponding to the operating information when the finger is in contact with the touch interface.

The aforementioned nail-mounted display system may further include a securing element connected to the display device for securing the display device on the finger. Preferably, the securing element secures the displayer device on a nail of the finger.

In an embodiment, the touch interface is a touch control display, and the operating information is a text or a picture.

In another embodiment, the touch interface is a touch sensor. Different touch locations on the touch sensor have different operating information.

Moreover, the positioning information of the touch location generated by the positioning module can be absolute coordinates or relative coordinates.

From the above, it is clear that when a user is operating on an electronic device having a touch control display, such as a smart phone, the nail-mounted display system of the present invention makes any operating information such as texts or pictures blocked by the user's finger be displayed on the display device worn on the finger. Alternatively, when the user is operating an electronic device having a touch sensor without display capability, such as a MP3 player, the display device displays corresponding operating information of the MP3. This overcomes the prior-art problem in that the user who tries to operate the display device is unable to obtain operating information since the screen is blocked by his/her finger or the display device has no display capability.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram depicting basic components of a nail-mounted display system in accordance with the present invention;

FIG. 2A is a block diagram depicting a nail-mounted display system in accordance with an embodiment of the present invention;

FIG. 2B is a schematic diagram depicting an implementation of a display device of the nail-mounted display system in accordance with the present invention;

FIG. 2C is a schematic diagram depicting an implementation of an electronic device of the nail-mounted display system in accordance with the present invention;

FIG. 3 is a schematic diagram depicting another implementation of the electronic device of the nail-mounted display system in accordance with the present invention;

FIG. 4A is a schematic diagram depicting the nail-mounted display system when in use in accordance with the present invention;

FIG. 4B is a block diagram depicting a nail-mounted display system in accordance with another embodiment of the present invention; and

FIG. 5 is a block diagram depicting the display device of a nail-mounted display system in accordance with another embodiment of the present invention.

### DETAILED DESCRIPTION OF THE EMBODIMENTS

The present invention is described by the following specific embodiments. Those with ordinary skills in the arts can readily understand other advantages and functions of the present invention after reading the disclosure of this specification.

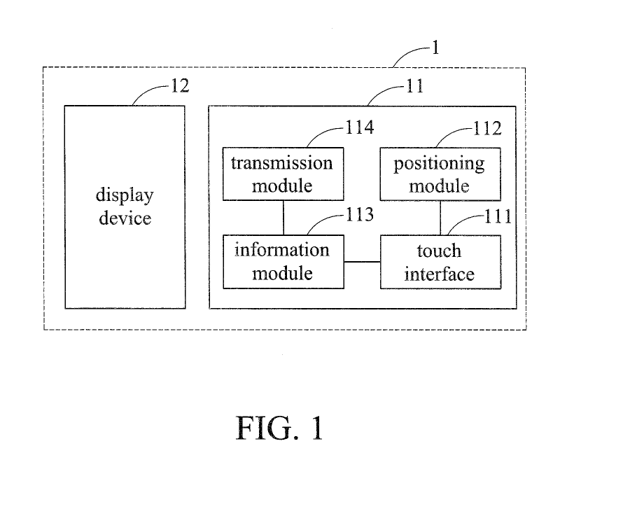

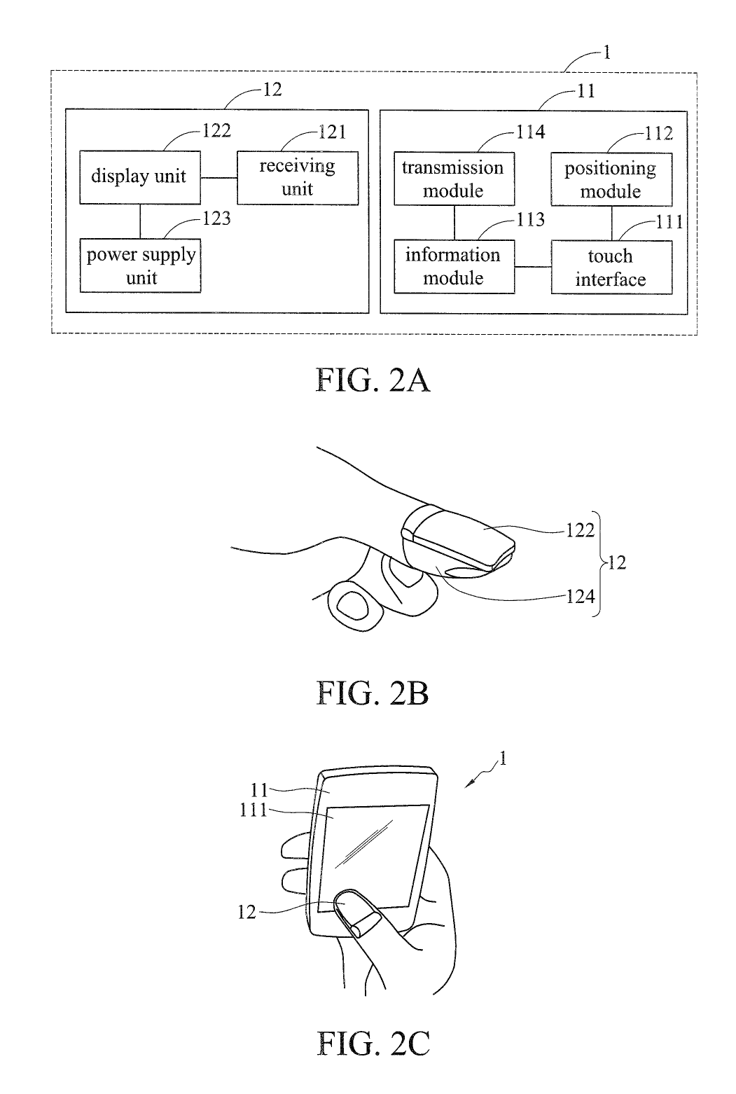

Referring to FIGS. 1 and 2A to 2C, a nail-mounted display system 1 in accordance with an embodiment of the present invention includes an electronic device 11 and a display device 12 in communication with the electronic device 11. The electronic device 11 includes a touch interface 111, a positioning module 112, an information module 113 and a transmission module 114.

A user's finger is in contact with the touch interface 111 to manipulate the electronic device 11. The place where the finger is in contact with the touch interface 111 is defined as a touch location. The touch interface 111 has operating information corresponding to the touch location. The touch interface 111 can be, for example, a touch control display of a mobile phone or a tablet computer, or a touch sensor of a general electronic device that can sense the strength and distribution of the force or the pressure exerted by the finger.

The positioning module 112 generates positioning information corresponding to the touch location when the finger is touching the touch interface 111. The positioning information of the touch location can be, for example, absolute coordinates (e.g. (x, y)) or relative coordinates (e.g. (x2-x1, y2-y1)).

The information module 113 obtains the operating information corresponding to the touch location on the touch interface 111 based on the positioning information, and then the transmission module 114 outputs the operating information obtained by the information module 113. More specifically, there is different operating information on different locations of the touch interface 111, and the information module 113 can obtain operating information, such as a text or a picture, corresponding to the touch location where the finger is touching the touch interface 111.

As shown in FIG. 2A, the display device 12 may include a receiving unit 121, a display unit 122 and a power supply unit 123. The receiving unit 121 is mainly used for receiving the operating information transmitted by the electronic device 11. The display unit 122 is used for displaying the operating information received by the receiving unit 121. The power supply unit 123 is used for providing the power required by the display device 12, wherein the display unit 122 can be a light emitting diode, an organic light emitting diode, a thin-film transistor liquid crystal display or a T-SWNT display, for example.

As shown in FIG. 2B, the display device 12 further includes a securing element 124 for securing the display device 12 on the finger. In FIG. 2B, the securing element 124 is in the form of a finger ring that can be worn on the nail of the user. It is to be noted that a finger ring is merely an illustrative example of the present invention, and the present invention is not limited as such. The display unit 122 can be adhered onto the finger or secured to the finger in other ways.

As shown in FIG. 2C, the electronic device 11 includes the touch interface 111 for the user to operate on. In this embodiment, the electronic device 11 is a mobile phone, and the touch interface 111 is a touch display for displaying information, and the user may manipulate the electronic device 11 by clicking directly on the touch interface 111 or dragging on the surface of the touch interface 111.

Since when the user is operating on the touch interface 111 with a finger, some parts of the screen will be blocked by the finger of the user, the user will not be able see the information displayed by the touch display. Thus, by wearing the display device 12 on the finger at a location where the nail is and performing a click operation on the touch interface 111 with the finger wearing the display device 12, the touch interface 111 will display the operating information while the user is operating, and the positioning module 112 will generate positioning information of absolute coordinates based on the touch location on the touch interface 111 touched by the user, the information module 113 will obtain operating information corresponding to the touch location based on the positioning information, and then the transmission module 114 will transmit the obtained operating information to the display device 12.

After the display device 12 receives the operating information from the electronic device 11 via the receiving unit 121, the display unit 122 can display the operating information. Therefore, when the user is operating on the touch interface 111 with the finger by clicking or dragging, the display device 12 can immediately display the operating information on the electronic device 11 that is currently being blocked by the finger. As a result, this solves the problem that some part of the operating information is blocked by the finger while the user is operating on the electronic device 11.

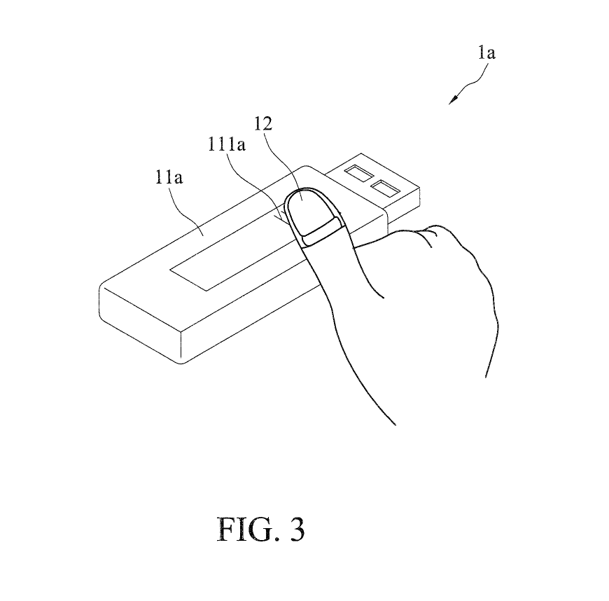

Referring to FIG. 3, the components and the functions of the components of a nail-mounted display system la in accordance with another embodiment of the present invention are similar to those shown in FIG. 1 except that the touch interface 111a of the electronic device 11a in this embodiment is a touch sensor, and thus the functions of the same components will not be repeated herein. The differences are as follow. When a user touches the touch interface 111a, the touch sensor then detects the location of the touch. Meanwhile, the positioning module 112 will generate positioning information of relative coordinates based on the location of the touch on the touch interface 111a, and the information module 113 will then obtain operating information corresponding to the touch location based on the positioning information, and the transmission module 114 will transmit the obtained operating information to the display device 12.

For example, if the electronic device 11a is a MP3 player with no display, and there are 10 songs stored in the electronic device 11a, wherein each song has corresponding coordinate information. When the user touches the touch interface 111a, the touch interface 111a detects the location of the touch interface 111a touched by the user, for example, (0, 6), and then the user drags to another touch location (e.g. (0, 8)) on the touch interface 111a, this incurs relative coordinates of (0, 2). Then, the information module 113 obtains the operating information, that is, a specific song, corresponding to the touch location on the touch interface 111a based on the relative coordinates. Thereafter, the transmission module 114 transmits the obtained operating information to the display device 12. The display device 12 receives and displays the operating information sent by the electronic device 11a. The components and function of the display device 12 are similar to those shown in FIG. 1A, and thus not described repeatedly.

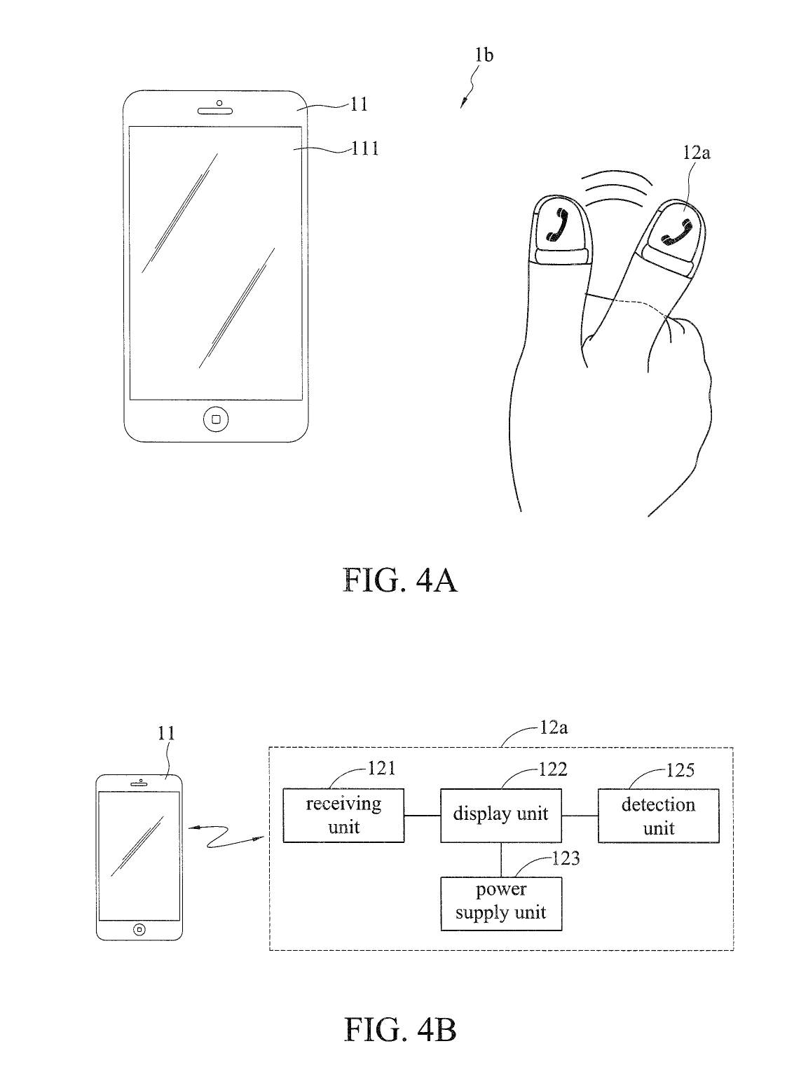

Referring to FIGS. 4A and 4B, the components and the functions of the components of a nail-mounted display system lb in accordance with another embodiment of the present invention are similar to those shown in FIG. 1 except that the display device 12a of this embodiment further includes a detection unit 125 for detecting a swinging motion of the display device 12a, and transmitting a corresponding control signal to the electronic device 11 accordingly, and thus the functions of the same components will not be repeated herein. In other words, the user can control the electronic device 11 by shaking the display device 12a.

More specifically, when the user would like to operate the electronic device 11, he/she only needs to shake the finger wearing the display device 12a, the display device 12a will then detect the movements caused by the user's finger and generate a corresponding control signal according to the shaking of the user, and the receiving unit 121 transmits this control signal to the electronic device 11. After the electronic device 11 receives the control signal, it will execute an action corresponding to the control signal, or return any information to be displayed by the display unit 122 of the display device 12a.

For example, if the electronic device 11 is a mobile phone, and when there is an incoming call, the user can be notified of this incoming call by the display unit 122 of the display device 12a, and the user can then decide to take this call by shaking his/her finger. When there is no incoming call, the user may also shake his/her finger to select a function menu of the electronic device 11, and perform simple operations on the electronic device 11 by again shaking his/her finger.

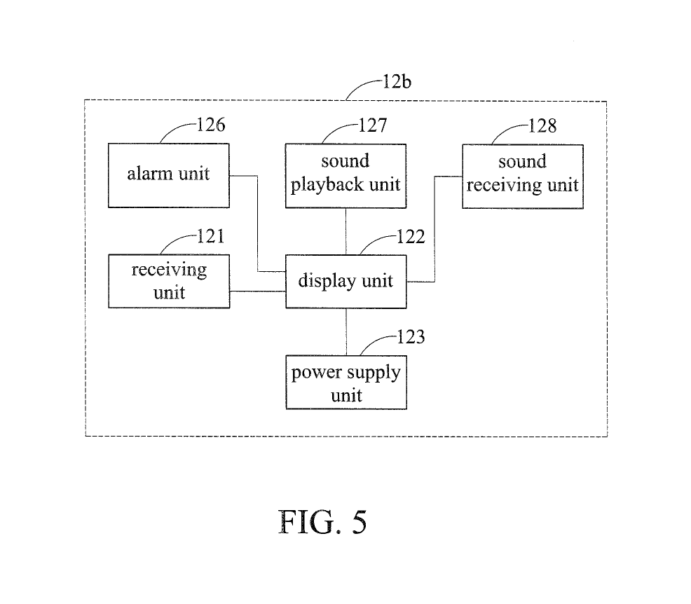

Referring to FIG. 5, in this embodiment, in addition to the functions described above, the display device 12b further includes an alarm unit 126, a sound playback unit 127 and a sound receiving unit 128. The alarm unit 126 may issue a sound alert or vibration alert to make a sound, emit a light, or vibrate upon actuation of the electronic device 11, or issue a sound alert when the power of power supply unit 123 is too low to allow normal operations of the display device 12b to notify the user that the power supply unit 123 is in a lower power state. The alert may also be in the form of vibration or light, for example. In the case that the electronic device 11 is a mobile phone, when there is an incoming call, the alarm unit 126 of the display device 12b may cause vibrations to alert the user. The sound playback unit 127 is used to receive and playback sounds from the electronic device 11. For example, when the electronic device 11 receives an incoming call, the electronic device 11 may transmit a ringtone to the display device 12b, which then plays the ringtone sent by the electronic device 11. The sound receiving unit 128 is a microphone, for example, which receives the sounds made by the user so as to allow the user to control the electronic device 11 by his/her voice.

The above embodiments are only used to illustrate the principles of the present invention, and should not be construed as to limit the present invention in any way. The above embodiments can be modified by those with ordinary skill in the art without departing from the scope of the present invention as defined in the following appended claims.

What is claimed is:

1. A nail-mounted display system, comprising:
an electronic device, comprising:
a touch interface to be in contact with a finger of a user for operating the electronic device, wherein where the touch interface is in contact with the finger is defined as a touch location, and the touch interface has operating information corresponding to the touch location;
a positioning module for generating positioning information corresponding to the touch location when the finger is in contact with the touch interface;
an information module for obtaining the operating information corresponding to the touch location on the touch interface based on the positioning information; and
a transmission module for outputting the operating information obtained by the information module; and
a display device to be worn on the finger for receiving the operating information corresponding to the touch location to display an image corresponding to the operating information when the finger is in contact with the touch interface.

2. The nail-mounted display system of claim 1, further comprising a securing element connected to the display device for securing the display device on the finger.

3. The nail-mounted display system of claim 2, wherein the securing element secures the display device on a nail of the finger.

4. The nail-mounted display system of claim 1, wherein the touch interface is a touch control display, and the operating information is a text or a picture.

5. The nail-mounted display system of claim 4, wherein the position information of the touch location generated by the positioning module comprises absolute coordinates.

6. The nail-mounted display system of claim 1, wherein the touch interface is a touch sensor, and the operating information is stored in the electronic device and corresponds to the touch location.

7. The nail-mounted display system of claim 6, wherein the position information of the touch location generated by the positioning module comprises relative coordinates.

8. The nail-mounted display system of claim 1, wherein the display device comprises a receiving unit, a display unit and a power supply unit, the receiving unit receives the operating information transmitted by the electronic device, the display unit displays the operating information received by the receiving unit, and the power supply unit provides power required for operations of the display device.

9. The nail-mounted display system of claim 1, wherein the display device further comprises a detection unit for detecting a swinging motion of the display device and transmitting a control signal to the electronic device accordingly, and the electronic device executes a corresponding action based on the control signal.

10. The nail-mounted display system of claim 1, wherein the display device further comprises an alarm unit for causing vibrations or sounds or emitting a light upon actuation of the electronic device.
